(19) United States
(12) Patent Application Publication
(10) Pub. No.: US 2015/0002064 A1
(43) Pub. Date: Jan. 1, 2015

(54) CIRCUIT FOR DETECTING ROTOR POSITION, APPARATUS AND METHOD FOR MOTOR DRIVING CONTROL USING THE SAME

(71) Applicant: SAMSUNG ELECTRO-MECHANICS CO., LTD., Suwon (KR)

(72) Inventors: Joo Yul Ko, Suwon (KR); Tae Ho Lim, Suwon (KR)

(73) Assignee: SAMSUNG ELECTRO-MECHANICS CO., LTD., Suwon (KR)

(21) Appl. No.: 14/037,317

(22) Filed: Sep. 25, 2013

(30) Foreign Application Priority Data
Jun. 28, 2013 (KR) 10-2013-0076026

(51) Int. Cl. H02P 6/18

(52) U.S. Cl. CPC H02P 6/18
USPC 318/400.32

(57) ABSTRACT

There are provided a circuit for detecting a rotor position, and an apparatus and a method for motor driving control using the same. The circuit for detecting a rotor position includes a sampling unit sampling a plurality of phase currents flowing in a plurality of phases to provide sampled phase currents; and a comparison unit comparing the sampled phase currents with one another to determine a phase having a minimum or maximum value.

### CROSS-REFERENCE TO RELATED APPLICATIONS

This application claims the priority of Korean Patent Application No. 10-2013-0076026 filed on Jun. 28, 2013, in the Korean Intellectual Property Office, the disclosure of which is incorporated herein by reference.

### BACKGROUND OF THE INVENTION

1. Field of the Invention

The present invention relates to a circuit for detecting a rotor position, and an apparatus and a method for motor driving control using the same.

2. Description of the Related Art

As motor technology evolves, motors having various sizes have been used in a wide range of technical fields.

Typically, a motor is driven by rotating a rotor using a permanent magnet and a coil having polarities changed according to a current applied thereto. A brush-type motor having a coil on a rotor has commonly been used; however, such a motor may have problems such as a brush being worn out or sparks occurring due to the driving of the motor.

For this reason, various types of brushless motor are commonly being used at present. A brushless motor is a direct current-type motor, from which mechanically contacting portions such as a brush and a commutator are eliminated and is driven using an electromagnetic commutating unit instead. This includes a rotor made of a permanent magnet and a plurality of stators each corresponding to a phase, so that the rotor is rotated by the magnetic force generated by the phase voltage of a coil of each of the stators.

Therefore, it is very important to know the position of the rotor in order to accurately drive such a brushless motor.

In the related art, a sensor motor using a hole sensor has been used for determining the position of the rotor. However, using such a hole sensor increases the size of a motor and makes it complicated, such that it is not applicable to recent motors which are constantly being decreased in size.

Recently, an approach has been developed in which currents are randomly applied to a motor at the time of initial driving to forcibly cause rotation and determines the position of the rotor according to the rotation. However, such an approach may allow for reverse rotation of the motor due to the randomly applied current so that the motor may be damaged due to the reverse rotation.

Patent Document 1 discloses a method for aligning the position of a rotor of an SRM and an SRM driving circuit for realizing the method, but cannot address the above-mentioned problems.

### RELATED ART DOCUMENT

(Patent Document 1) Korean Patent Laid-Open Publication No. 2001-0100648

### SUMMARY OF THE INVENTION

An aspect of the present invention provides a circuit for detecting a rotor position capable of determining a rotor position having a smaller area and a simpler circuit configuration by way of comparing phase currents of a motor according to an initial driving signal with one another using a comparator, and an apparatus and a method for motor driving control using the same.

According to an aspect of the present invention, there is provided a circuit for detecting a rotor position including: a sampling unit sampling a plurality of phase currents flowing in a plurality of phases to provide sampled phase currents; and a comparison unit comparing the sampled phase currents with one another to determine a phase having a minimum or maximum value.

The comparison unit may include a comparator receiving any one of the plurality of phase currents as a first signal and another one of the plurality of phase currents as a second signal.

The comparison unit may further include a state device which determines the first and second signals to be input to the comparator from among the plurality of phase currents using a predetermined comparison algorithm.

The comparison unit may further include a switch array, connected to the sampling unit and the comparator in series, and switched under the control of the state device such that a portion of the phase currents among the plurality thereof are input to the comparator.

The sampling unit may include a plurality of sample and holders which samples and holds the phase currents according to a predetermined criterion.

The circuit may further include a level shifter converting the phase voltages sensed during the multi phases of the motor into a predetermined level range, wherein the plurality of phase currents correspond to the phase voltages output from the level shifter.

According to another aspect of the present invention, there is provided an apparatus for motor driving control, including: a driving signal generating unit providing an initial driving signal including a short pulse train; an inverter unit generating a driving current corresponding to the initial driving signal so as to provide the driving current to the motor; and a rotor position detecting unit comparing the phase currents of the motor generated by the driving current with one another so as to detect the rotor position of the motor.

The rotor position detecting unit may include: a sampling unit sampling a plurality of phase currents flowing in a plurality of phases to provide sampled phase currents; and a comparison unit comparing the sampled phase currents with one another to determine a phase having a minimum or maximum value.

The comparison unit may include a comparator receiving any one of the plurality of phase currents as a first signal and another one of the plurality of phase currents as a second signal.

The comparison unit may further include a state device which determines the first and second signals to be input to the comparator from among the plurality of phase currents using a predetermined comparison algorithm.

The comparison unit may further include a switch array, connected to the sampling unit and the comparator in series, and switched under the control of the state device such that a portion of the phase currents among the plurality thereof are input to the comparator.

The rotor position detecting unit may further include a level shifter converting the phase voltages sensed during the multi phases of the motor into a predetermined level range, wherein the plurality of phase currents correspond to the phase voltages output from the level shifter.

The apparatus may further include a control unit controlling the driving of the motor using a determined position of the rotor when the position of the rotor is determined by the rotor position detecting unit.

The control unit may generate a driving signal under the control of the control unit when the position of the rotor is determined, and provide the generated driving signal in replacement of the initial driving signal.

According to another aspect of the present invention, there is provided a method for motor driving control performed in an apparatus for controlling motor driving, the method including: providing a predetermined initial driving signal to the motor; sampling a plurality of phase currents flowing in a plurality of phases of the motor according to the initial driving signal; and comparing phase currents among the sampled plurality of phase currents with one another to determined a phase having a minimum or maximum value, and detecting a rotor position of the motor using the result.

The sampling of the plurality of phase currents may include: converting the phase voltages sensed during the plurality of phases into a predetermined level range; and performing sampling using the plurality of phase currents corresponding to the converted phase voltages.

The sampling may include sampling each of the plurality of phase currents at a predetermined time; and holding and outputting the sampled phase currents.

The detecting of the rotor position of the motor may include: determining first and second signals to be input to a comparator from among the plurality of phase currents using a predetermined comparison algorithm; and determining a phase having a minimum or maximum value from among the plurality of phase currents using the comparator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating the configuration of an apparatus for motor driving control according to an embodiment of the present invention;

FIG. 2 is a circuit diagram illustrating the inverter unit shown in FIG. 1 according to an embodiment of the present invention;

FIG. 3 is a circuit diagram illustrating the rotor position detecting unit shown in FIG. 1 according to an embodiment of the present invention;

FIG. 4 is a timing signal diagram illustrating signals of an apparatus for motor driving control according to an embodiment of the present invention;

FIG. 5 is a flow chart illustrating a method for motor driving control according to an embodiment of the present invention; and

FIG. 6 is a flow chart illustrating a comparison algorithm performed in the state device shown in FIG. 3.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

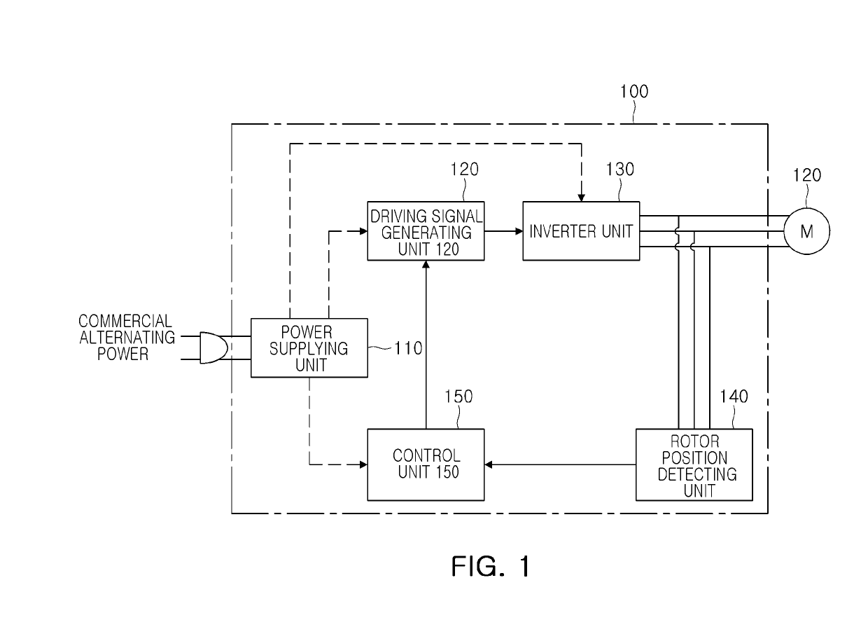

FIG. 1 is a diagram illustrating the configuration of an apparatus for motor driving control according to an embodiment of the present invention.

A motor 200 is rotatably operable according to a driving signal. For example, magnetic fields may be generated in coils of the motor 200 by a driving current provided from the inverter unit 130. A rotor included in the motor 200 may be rotated by the magnetic fields generated in the coils.

The apparatus for motor driving control 100 may control the driving of the motor 200 by providing a driving signal to the motor 200.

Specifically, the apparatus for motor driving control 100 may include a power supplying unit 110, a driving signal generating unit 120, an inverter unit 130, a rotor position detecting unit 140, and a control unit 150.

The power supply unit 110 may supply power to each of the components in the apparatus for motor driving control 100. For example, the power supplying unit 110 may convert a household alternating current (AC) voltage into a direct current (DC) voltage to supply the converted DC voltage. In the example shown in FIG. 1, dashed lines refer to currents supplied from the power supplying unit 110.

The driving signal generating unit 120 may provide a driving control signal to the inverter unit 130.

In an embodiment, the driving signal generating unit 120 may provide an initial driving signal to the inverter unit 130. The initial driving signal is provided to determine the position of the rotor when the motor 200 is stationary. In an embodiment, the initial driving signal may include a short pulse train.

The inverter unit 130 may generate a driving current for operating the motor 200.

For example, the inverter unit 130 may convert a DC voltage into a multi-phase (for example, a three-phase or a four-phase) voltage according to the driving signal, and apply the multi-phase voltage to each of the coils (corresponding to the multi phases) of the motor 200, thereby generating magnetic fields.

Upon receiving the initial driving signal from the driving signal generating unit 120, the inverter unit 130 may generate a corresponding driving current to provide it to the motor 200.

When phase currents of the motor 200 are generated by the driving current provided from the inverter unit 130, the rotor position detecting unit 140 compares the phase currents with one another so as to detect the rotor position of the motor.

In an embodiment, the motor 200 may have multi phases, and each of the multi phases may be supplied with a driving current at its positive (+) terminal and negative (−) terminal. The rotor position detecting unit 140 may sample the multi-phase currents flowing in the multi-phases, compare the sampled phase currents with one another, and determine the phase having the minimum or maximum value, so as to detect the position of the rotor.

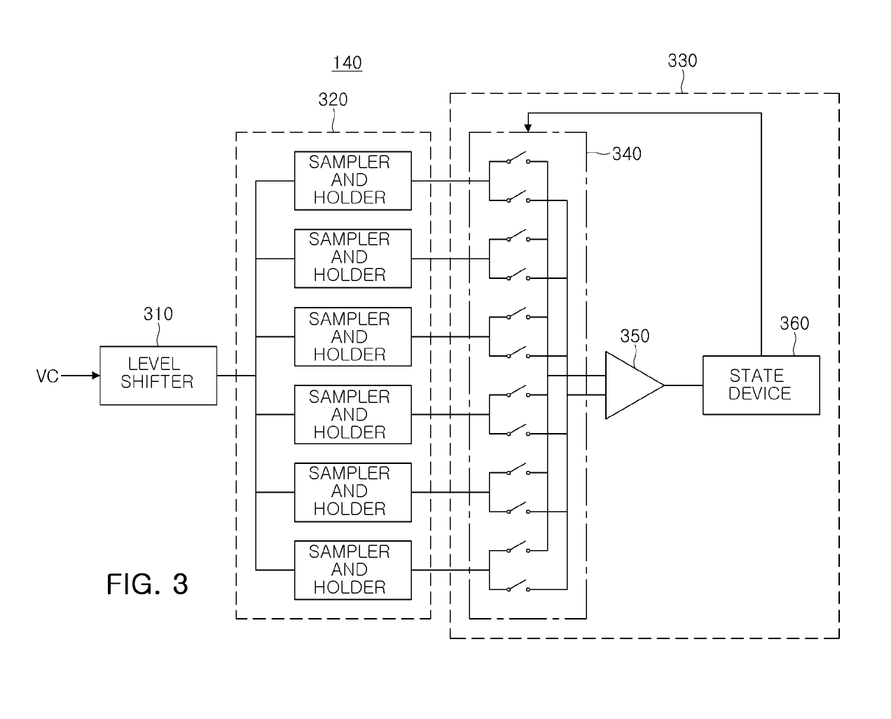

Variants of the rotor position detecting unit 140 will be described below in more detail with reference to FIG. 3.

When the position of the rotor is detected by the rotor position detecting unit 140, the control unit 150 may control the driving of the motor 200 using the detected position of the rotor.

In controlling the driving of the motor 200, the control unit 150 may determine the phase commutation point of the motor 200, and control the driving signal generating unit 120 so that it generates a driving signal using the determined phase commutation point in time. For example, the control unit 150 may control the driving signal generating unit 120 so that it performs phase commutation at a zero-crossing point of the back-electromotive force.

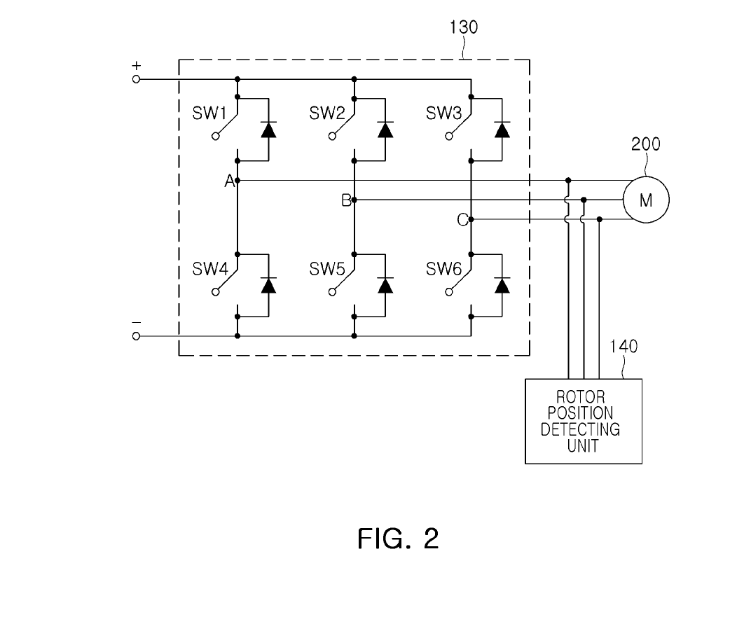

FIG. 2 is a circuit diagram illustrating the inverter unit shown in FIG. 1 according to an embodiment of the present invention.

Referring to FIG. 2, the inverter unit 130 includes a plurality of upper switch elements SW1 to SW3 connected to a positive (+) terminal, and a plurality of lower switch elements SW4 to SW6 provided between each of the upper switch elements SW1 to SW3 and the power terminal. The contact points between the upper switch elements SW1, SW2 and SW3 and the lower switch elements SW4, SW5 and SW6, respectively, are connected to the coils A, B and C of the motor 200, respectively.

The upper switch elements SW1 to SW3 of the inverter unit 130 are sequentially turned on, and the lower switch elements SW4 to SW6 are switched in opposition to the upper switch elements SW1 to SW3 to which they are connected. Here, when the switch element SW1 is turned on, positive (+) voltage is applied to the coil A of the motor 200, and when the switch element SW6 is turned on during the operation, negative (−) voltage is applied to the coil C. By doing so, magnetic forces having opposite polarities are generated between the coil A and the coil C, and the rotor is rotated by 60 degree by the interaction of the magnetic forces. Then, when the switch element SW1 is turned off and the switch element SW2 is turned on, a magnetic force having a polarity opposite to the magnetic force generated in the coil C is generated in the coil B, and the rotor is further rotated by 60 degrees. Similarly, while the switch element SW2 is in on state, when the switch element SW6 is turned off and the switch element SW4 is turned on, a magnetic force having a polarity opposite to the magnetic force generated in the coil B is generated in the coil A, and the rotor is further rotated by 60 degrees. By repeating the procedures, the rotor continues to rotate and thereby the motor 200 operates.

The rotor position detecting unit 140 may detect the position of the rotor using current or voltage on the multi phases. The example shown illustrates the inverter unit 130 for the three-phase motor 200, and accordingly, the number of a plurality of phase currents or phase voltages used in the rotor position detecting unit 140 is six.

FIG. 3 is a circuit diagram illustrating the rotor position detecting unit shown in FIG. 1 according to an embodiment of the present invention. As shown in FIG. 3, the rotor position detecting unit 140 may be a type of circuit, a rotor position detecting circuit.

Referring to FIG. 3, the rotor position detecting unit 140 may include a sampling unit 320 and a comparison unit 330. In some embodiments, the rotor position detecting unit 140 may further include a level shifter 310.

The level shifter 310 may convert a phase voltage VC sensed on the multi phases of the motor 200 into a voltage in a predetermined level range. This is to increase the level of the detected voltage up to a voltage level for comparison when it is too low to be compared. Here, the plurality of phase currents may correspond to the phase voltage output from the level shifter 310.

The sampling unit 320 may sample the plurality of phase currents flowing in the multi phases of the motor 200 to provide the sampled current.

In an embodiment, the sampling unit 320 may further include a sample and holder 320.

The sample and holder 320 may sample each of the multi phase currents according to a predetermined criterion and hold the sampled current.

In an embodiment, the number of the sample and holders 320 may correspond to that of the multi phases. In the shown example, a three-phase motor is shown and thus a total of six sample and holders are used.

In an embodiment, the sample and holder 320 may receive a clock input signal individually provided, and apply a predetermined criteria to the received clock input signal so as to individually perform sampling.

The comparison unit 330 may compare the sampled, multi phase currents with one another, to determine the phase having the minimum or maximum value.

The comparison unit 330 may include a switch array 340, a comparator 350, and a state device 360.

The switch array 340 may be connected to the sampling unit 320 and the comparator 350 in series. The switch array 340 may be switched under the control of the state device 360 so that a portion of the phase currents among the plurality thereof are input to the comparator 350.

The comparator 350 may receive any of the plurality of phase currents as a first signal and receive another of the remainder of the plurality of phase currents as a second signal so as to compare one with another. Here, the first and second signal may be selected or changed by the switching of the switch array 340.

Here, it is noted that the comparator 350 receives different phase currents as the two inputs. That is, while a typical comparator receives a reference signal as an input, the comparator 350 according to the embodiment receives two phase currents selected from the plurality of phase currents via the switch array 340 as input signals. By doing so, the present invention may determine a phase having the minimum or maximum value according to various algorithms with one comparator 350.

The state device 360 may use a comparison algorithm to determine first and second signals to be input to the comparator 350 from among the plurality of phase currents. Here, the comparison algorithm may use a tournament scheme, a sequential comparison scheme and the like, and the present invention is not limited a particular algorithm.

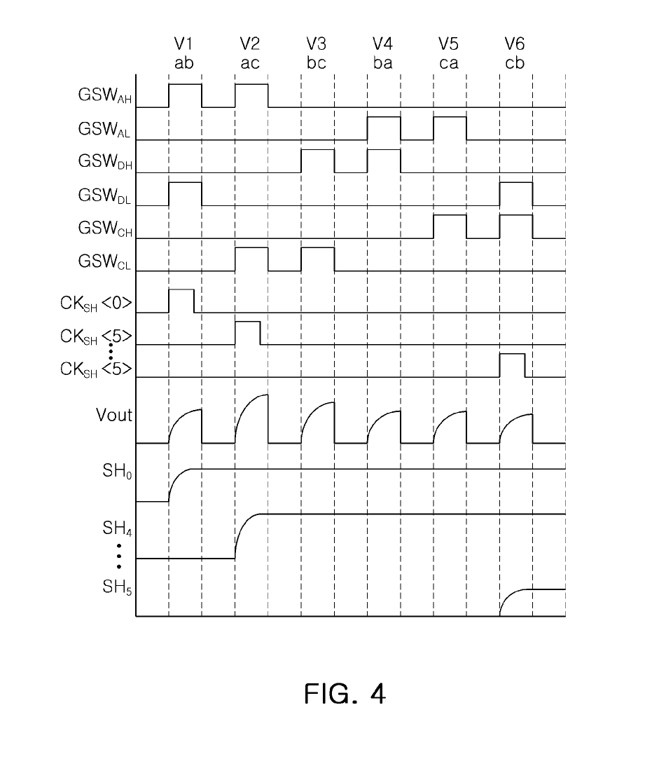

FIG. 4 is a timing signal diagram illustrating signals of an apparatus for motor driving control according to an embodiment of the present invention.

In FIG. 4, CKSH denotes a clock input signal input to the sample and holder 320, and SH denotes to an output signal from the sample and holder 320. GSW denotes a driving signal input to the motor 200, where a subscript denotes a phase of the motor 200.

As shown, at the time when a clock input signal input to the sample and holder 320 is changed from high to low, the sample and holder 320 may sample the voltage so as to output a corresponding current (phase current).

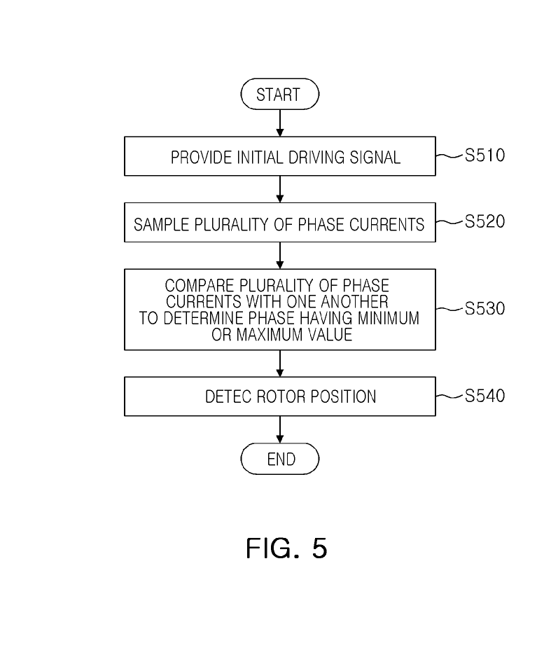

FIG. 5 is a flow chart illustrating a method for motor driving control according to an embodiment of the present invention.

Hereinafter, a method for a motor driving control according to the embodiment of the present invention will be described with reference to FIG. 5. Since the example of the method for motor driving control according to the embodiment is performed in the apparatus for motor driving control 100 described above with reference to FIGS. 1 to 4, an overlapped description on parts that are the same as or correspond to the above-mentioned parts will be omitted.

Referring to FIGS. 1 to 5, the apparatus for motor driving control 100 may provide an initial driving signal to the motor 200 (S510).

Then, the apparatus 100 may sample plurality of phase currents flowing in multi phases of the motor 200 according to the initial driving signal (S520).

The apparatus 100 may compare the sampled phase currents with one another to determine a phase having the minimum or maximum value (S530), and may detect the position of the rotor of the motor 200 using the result (S540).

In an example of the operation S520, the apparatus 100 may convert the phase voltages sensed in multi phases into a predetermined level range, and perform sampling using a plurality of phase currents corresponding to the converted phase voltages.

Here, the sampling may include sampling each of the plurality of phase currents at a predetermined time, and holding and outputting the sampled phase currents.

In an example of the operations S530 and S540, the apparatus 100 may determine first and second signals to be input to a comparator from among the plurality of phase currents using a predetermined comparison algorithm. Then, the apparatus 100 may determine a phase having the minimum or maximum value from among the phase current using the comparator.

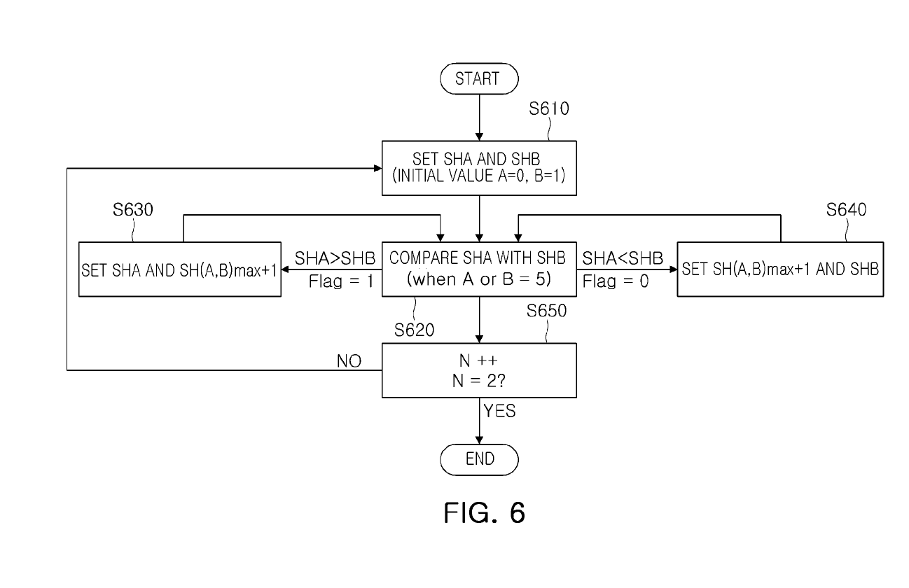

FIG. 6 is a flow chart illustrating a comparison algorithm performed in the state device shown in FIG. 3, and Table 1 is a reference table for describing the comparison algorithm shown in FIG. 6.

TABLE 1

| | SH_{A} | SH_{B} | Flag | Comparison |
|---|---|---|---|---|
| 1 | SH₀ | SH₁ | 0 | SH₀ < SH₁ |
| 2 | SH₁ | SH₂ | 1 | SH₂ > SH₁ |
| 3 | SH₂ | SH₃ | 0 | SH₂ < SH₃ |
| 4 | SH₃ | SH₄ | 1 | SH₄ > SH₃ |
| 5 | SH₄ | SH₅ | 1 | SH₄ < SH₅ |

In FIG. 6 and Table 1, SH denotes the sample and holder 320 of FIG. 3, and the comparison algorithm of the state device will be described with an example having six sample and holders SH0 to SH5 as shown in FIG. 3.

Initially, the state device 360 determines two sample and holders SHA and SHB (S610) to be compared (S610).

Then, the state device 360 compares the values of two sample and holders SHA and SHB with one another (S620), and holds the sample and holder having a larger value and replaces the sample and holder having a smaller value with another (S630 and S640). The operations are repeated. Table 1 illustrates an example of such operations.

Such operations are repeated until any of the sample and holders is the last sample and holder SH5, and then the process exits from the comparison operation S620 and it is determined whether the process is to be ended (S650).

In the shown example, the ending process is performed by comparing a comparison constant N. The comparison constant N is incremented by 1 (N++) whenever one comparison is completed, and it is determined whether to end the process by determining the incremented comparison constant N reaches a threshold value (2 in the shown example).

As set forth above, according to embodiments of the present invention, a rotor position can be determined with a smaller area and a simpler circuit configuration by way of comparing phase currents of a motor according to an initial driving signal with one another using a comparator. Further, by configuring a simpler circuit using a comparator, an integrated circuit can be simply implemented and the manufacturing cost can be efficiently reduced.

While the present invention has been shown and described in connection with the embodiments, it will be apparent to those skilled in the art that modifications and variations can be made without departing from the spirit and scope of the invention as defined by the appended claims.

What is claimed is:

1. A circuit for detecting a rotor position, comprising:
a sampling unit sampling a plurality of phase currents flowing in a plurality of phases to provide sampled phase currents; and
a comparison unit comparing the sampled phase currents with one another to determine a phase having a minimum or maximum value.

2. The circuit of claim 1, wherein the comparison unit includes a comparator receiving any one of the plurality of phase currents as a first signal and another one of the plurality of phase currents as a second signal.

3. The circuit of claim 2, wherein the comparison unit further includes a state device which determines the first and second signals to be input to the comparator from among the plurality of phase currents using a predetermined comparison algorithm.

4. The circuit of claim 3, wherein the comparison unit further includes a switch array, connected to the sampling unit and the comparator in series, and switched under the control of the state device such that some of the plurality of phase currents are input to the comparator.

5. The circuit of claim 1, wherein the sampling unit includes a plurality of sample and holders, wherein each of the sample and holders samples and holds the phase currents according to a predetermined criterion.

6. The circuit of claim 1, further comprising a level shifter converting the phase voltages sensed during the multi phases of the motor into a predetermined level range, wherein the plurality of phase currents correspond to the phase voltages output from the level shifter.

7. An apparatus for motor driving control, comprising:
a driving signal generating unit providing an initial driving signal including a short pulse train;
an inverter unit generating a driving current corresponding to the initial driving signal so as to provide the driving current to the motor; and
a rotor position detecting unit comparing the phase currents of the motor generated by the driving current with one another so as to detect the rotor position of the motor.

8. The apparatus of claim 7, wherein the rotor position detecting unit includes: a sampling unit sampling a plurality of phase currents each flowing in a plurality of phases to provide sampled phase currents; and a comparison unit comparing the sampled phase currents with one another to determine a phase having a minimum or maximum value.

9. The apparatus of claim 8, wherein the comparison unit includes a comparator receiving any one of the plurality of phase currents as a first signal and another one of the plurality of phase currents as a second signal.

10. The apparatus of claim 9, wherein the comparison unit further includes a state device which determines the first and second signals to be input to the comparator from among the plurality of phase currents using a predetermined comparison algorithm.

11. The apparatus of claim 10, wherein the comparison unit further includes a switch array, connected to the sampling unit and the comparator in series, and switched under the control of the state device such that a portion of the phase currents among the plurality thereof are input to the comparator.

12. The apparatus of claim 8, wherein the rotor position detecting unit further includes a level shifter converting the phase voltages sensed during the plurality of phases of the motor into a predetermined level range, wherein the plurality of phase currents correspond to the phase voltages output from the level shifter.

13. The apparatus of claim 7, further comprising a control unit controlling the driving of the motor using a determined position of the rotor when the position of the rotor is determined by the rotor position detecting unit.

14. The apparatus of claim 13, wherein the control unit generates a driving signal under the control of the control unit when the position of the rotor is determined, and provides the generated driving signal in replacement of the initial driving signal.

15. A method for motor driving control performed in an apparatus for controlling motor driving, the method comprising:
providing a predetermined initial driving signal to the motor;
sampling a plurality of phase currents flowing in a plurality of phases of the motor according to the initial driving signal; and
comparing phase currents among the sampled plurality of phase currents with one another to determine a phase having a minimum or maximum value, and detecting a rotor position of the motor using the result.

16. The method of claim 15, wherein the sampling of the plurality of phase currents includes:
converting the phase voltages sensed during the plurality of phases into a predetermined level range; and
performing sampling using the plurality of phase currents corresponding to the converted phase voltages.

17. The method of claim 16, wherein the sampling includes:
sampling each of the plurality of phase currents at a predetermined time; and
holding and outputting each of the sampled, plurality of phase currents.

18. The method of claim 16, wherein the detecting of the rotor position of the motor includes:
determining first and second signals to be input to a comparator from among the plurality of phase currents using a predetermined comparison algorithm; and
determining a phase having a minimum or maximum value from among the plurality of phase currents using the comparator.
